(19) United States
(12) Patent Application Publication
(10) Pub. No.: US 2014/0324511 A1
(43) Pub. Date: Oct. 30, 2014

(54) BUSINESS PROCESS DISCOVERY USING DOCUMENT TRACKING TECHNOLOGIES

(71) Applicant: INTERNATIONAL BUSINESS MACHINES CORPORATION, Armonk, NY (US)

(72) Inventors: Salil Ahuja, Austin, TX (US); Amod V. Bhise, Round Rock, TX (US); Pankuj Chachra, Austin, TX (US)

(73) Assignee: International Business Machines Corporation, Armonk, NY (US)

(21) Appl. No.: 13/872,119

(22) Filed: Apr. 28, 2013

(51) Int. Cl. G06Q 10/06

(52) U.S. Cl. CPC G06Q 10/0633
USPC 705/7.26; 705/7.27

(57) ABSTRACT

A document tracking module is associated with a physical document utilized within a business organization. Physical movement of the document is monitored through different departments of the business organization using information derived from the document tracking module. A business process flow within the business organization is discovered from the monitored physical movement of the document through the different departments of the business organization. A business process model, including details of the discovered business process flow within the business organization, is generated.

### BACKGROUND

The present invention relates to business process modeling. More particularly, the present invention relates to business process discovery using document tracking technologies.

Business processes involve interactions between business departments, such as accounting and engineering departments. Employees within the respective business departments collaborate for project development, program development, and for other business purposes.

### BRIEF SUMMARY

A method includes associating a document tracking module with a physical document utilized within a business organization; monitoring, by a processor, physical movement of the document through different departments of the business organization using information derived from the document tracking module; discovering a business process flow within the business organization from the monitored physical movement of the document through the different departments of the business organization; and generating a business process model comprising details of the discovered business process flow within the business organization.

A system includes a memory and a processor programmed to: associate a document tracking module with a physical document utilized within a business organization; monitor physical movement of the document through the different departments of the business organization using information derived from the document tracking module; discover a business process flow within the business organization from the monitored physical movement of the document through different departments of the business organization; and generate within the memory a business process model comprising details of the discovered business process flow within the business organization.

A computer program product includes a computer readable storage medium having computer readable program code embodied therewith, where the computer readable program code when executed on a computer causes the computer to: associate a document tracking module with a physical document utilized within a business organization; monitor physical movement of the document through different departments of the business organization using information derived from the document tracking module; discover a business process flow within the business organization from the monitored physical movement of the document through the different departments of the business organization; and generate a business process model comprising details of the discovered business process flow within the business organization.

### BRIEF DESCRIPTION OF THE SEVERAL VIEWS OF THE DRAWINGS

FIG. 1 is a block diagram of an example of an implementation of a system for business process discovery using document tracking technologies according to an embodiment of the present subject matter;

FIG. 2 is a block diagram of an example of an implementation of a core processing module capable of performing business process discovery using document tracking technologies according to an embodiment of the present subject matter;

FIG. 3 is a diagram of a business process flow model that may be generated using business process discovery using document tracking technologies according to an embodiment of the present subject matter;

FIG. 4 is a flow chart of an example of an implementation of a process for business process discovery using document tracking technologies according to an embodiment of the present subject matter; and

FIG. 5 is a flow chart of an example of an implementation of a process for business process discovery using document tracking technologies that includes modification and simulation of discovered business process models according to an embodiment of the present subject matter.

### DETAILED DESCRIPTION

The examples set forth below represent the necessary information to enable those skilled in the art to practice the invention and illustrate the best mode of practicing the invention. Upon reading the following description in light of the accompanying drawing figures, those skilled in the art will understand the concepts of the invention and will recognize applications of these concepts not particularly addressed herein. It should be understood that these concepts and applications fall within the scope of the disclosure and the accompanying claims.

The subject matter described herein provides business process discovery using document tracking technologies. The present technology provides automated discovery of business processes and automated generation of business process models using document tracking technologies, such as radio frequency identification (RFID) and global positioning system (GPS) technologies. Content-driven process flows that operate by movement of physical business documents through a sequence of locations may be discovered and may be documented in an automated manner. As such, the automated generation of business process models described herein is based upon factual and programmatically-collected data regarding document movement that provides visibility into the actual business processes (as opposed to intended business processes that may not be followed in actuality) within existing organizations. Potential human input errors may be averted and potentially out-of-date intended business process documentation may be updated based upon the factual business process flows within an organization. As a result of the programmatic factual data collection and discovered business process model generation, the present technology may be utilized to improve business process flow documentation and understanding, and may further assist with the improvement of business process efficiency within organizations.

As an example of a use case where the present technology may be utilized, a company (e.g., an insurance agency) may be faced with a change (e.g., a health coding/code change) that may impact a certain part of its internal processing. A document may be sent from department to department for persons within the respective departments to fill in the impact of the change for implementation impact/analysis purposes with respect to the pending change. The present technology may be utilized to trace/track the business process as the document goes from department to department. The document may be tagged, for example with an RFID or GPS unit/device that may be used to trace the actual path the document takes within the organization. The present technology maps the business area where the document will be operated upon, and tracks the document tag as the document moves from department to department. The actual time that the document is within each department may also be calculated/captured to further characterize the actual business process of determining the impact of the change. At each location/department that is involved in the business process flow to determine the impact of the change, the tag may be queried or may autonomously send the current document location (e.g., the department). When the business process is completed, an actual/factual record has been captured/discovered with respect to where the document has been and who has worked on the document, including how long the document has remained within each department, and a number of reworks/re-routes through departments (if applicable), along with other information regarding the actual route taken by the document. As such, while this is but one example of a use case to which the present technology may be applied, it is understood that the present technology may be utilized to discover and document many other business processes, and all such business processes are considered within the scope of the present subject matter.

The business process models that are generated based upon the business process discovery may be utilized for a variety of purposes. For example, business process diagnostics, analytics, modification, simulations of business process modifications, and process automation based upon the discovered business process flow may all be performed. A process automation tool may also be utilized to automate part or all of the discovered business process, as appropriate for the given implementation. Further, versioning of the generated business process model may be performed based upon actual changes of document handling within the organization to provide business process model versioning for process improvements. Many other options are possible for use of the generated output of the discovered business process flow and all such possibilities are considered to be within the scope of the present technology.

It should be noted that conception of the present subject matter resulted from recognition of certain limitations associated with business process modeling and documentation. For example, it was observed that conventional modeling of business processes is dependent upon human input and existing (potentially obsolete or incomplete) business process documents. It was further observed that, even where intended business processes have been architected, deviations relative to the intended business processes occur frequently and these deviations are not captured by the intended business processes. Further, documentation may not be updated in response to changes/deviations in the actual implementation of intended business models. As a result, it was determined that existing “as-is” (e.g., actual) business processes often differ/deviate from the intended business processes based upon what people actually do during the course of their respective work on tasks associated with the intended business processes, and that business process modeling using conventional technologies may not lead to accurate documentation of the “as-is” business processes. It was further determined that, automated actual/as-is business process discovery, as described herein, may be implemented to improve upon business model documentation and analysis. Further, discovered business process modification may be implemented and iterative utilization of the business process discovery described herein may be used based upon inputs from many different parts of an organization (e.g., an enterprise organization) to accommodate changes in actual business process implementations over time. The present subject matter improves business process modeling and documentation by providing actual as-is business process modeling through business process discovery using document tracking technologies, as described above and in more detail below. As such, improved business process modeling and documentation may be obtained through use of the present technology.

The business process discovery using document tracking technologies described herein may be performed in real time to allow prompt discovery of business models from actual business practices. For purposes of the present description, real time shall include any time frame of sufficiently short duration as to provide reasonable response time for information processing acceptable to a user of the subject matter described. Additionally, the term “real time” shall include what is commonly termed “near real time”—generally meaning any time frame of sufficiently short duration as to provide reasonable response time for on-demand information processing acceptable to a user of the subject matter described (e.g., within a portion of a second or within a few seconds). These terms, while difficult to precisely define are well understood by those skilled in the art.

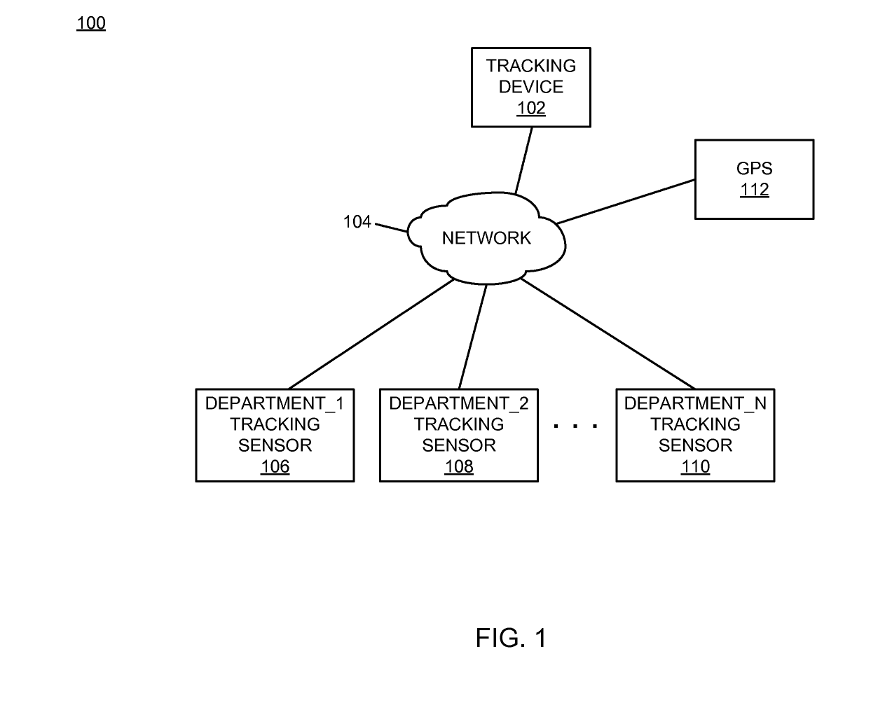

FIG. 1 is a block diagram of an example of an implementation of a system 100 for business process discovery using document tracking technologies. A tracking device 102 tracks document flows as the documents move from department to department within an organization as part of a business process flow. The tracking device 102 evaluates the actual paths traversed by documents and generates factual business process models that represent the actual paths traversed by the documents. The generated factual business process models may be document-specific business process models that are based upon discovered/captured data regarding the path of a single document within the organization or may be aggregated business process models that are based upon discovered/captured data regarding the path of several documents across several document flows.

The tracking device 102 communicates via a network 104 with a department_{—}1 tracking sensor 106, a department_{—}2 tracking sensor 108 through a department_N tracking sensor 110. The department_{—}1 tracking sensor 106 through the department_N tracking sensor 110 may each be situated within a department of an organization and may provide localized document tracking information, such as radio frequency identification (RFID) sensing of documents that enter and exit the respective departments. The tracking device 102 also communicates with a global positioning system (GPS) 112. The GPS 112 may provide globalized document tracking services across all departments of an organization. It is understood that the department_{—}1 tracking sensor 106 through the department_N tracking sensor 110 may be utilized in combination with the GPS 112, or that the respective department tracking sensors 106 through 110 may be utilized for certain implementations and the GPS 112 may be utilized for certain other implementations, as appropriate for the particular implementation environment. Each device represented within FIG. 1 may be considered a “computing device” for purposes of description, and may include processing capabilities to facilitate implementation of the present technology, and these processing capabilities may be adjusted as appropriate for the particular implementation environment.

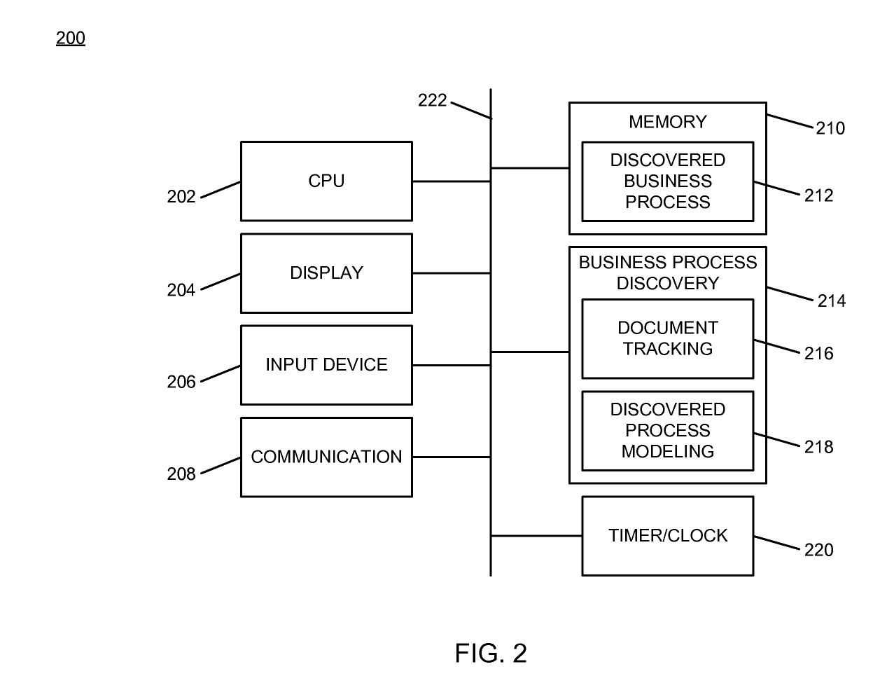

As will be described in more detail below in association with FIG. 2 through FIG. 5, the tracking device 102 provides automated business process discovery using document tracking technologies. The automated business process discovery using document tracking technologies is based upon measurement/tracking of actual document flows and documentation of actual business processes as implemented within an organization/environment. A variety of possibilities exist for implementation of the present subject matter, and all such possibilities are considered within the scope of the present subject matter.

It should be noted that any of the respective computing devices described in association with FIG. 1 may be portable computing devices, either by a user's ability to move the respective computing devices to different locations, or by the respective computing device's association with a portable platform, such as a plane, train, automobile, or other moving vehicle. It should also be noted that the respective computing devices may be any computing devices capable of processing information as described above and in more detail below. For example, the respective computing devices may include devices such as a personal computer (e.g., desktop, laptop, etc.) or a handheld device (e.g., cellular telephone, personal digital assistant (PDA), email device, tablet computing device, etc.), a web server, application server, or other data server device, or any other device capable of processing information as described above and in more detail below.

The network 104 may include any form of interconnection suitable for the intended purpose, including a private or public network such as an intranet or the Internet, respectively, direct inter-module interconnection, dial-up, wireless, or any other interconnection mechanism capable of interconnecting the respective devices.

The tracking device 102 may include any device capable of processing data generated by a device, such as the department_{—}1 tracking sensor 106 through the department_N tracking sensor 110 and the GPS 112. As such, the tracking device 102 may alternatively be implemented as a tracking server, a web server, an application server, or other data server device.

FIG. 2 is a block diagram of an example of an implementation of a core processing module 200 capable of performing business process discovery using document tracking technologies. The core processing module 200 may be associated with the tracking device 102, or with any of the department_{—}1 tracking sensor 106 through the department_N tracking sensor 110 and the GPS 112, as appropriate for a given implementation. As such, the core processing module 200 is described generally herein, though it is understood that many variations on implementation of the components within the core processing module 200 are possible and all such variations are within the scope of the present subject matter.

Further, the core processing module 200 may provide different and complementary processing of business process discovery using document tracking technologies in association with each implementation. As such, for any of the examples below, it is understood that any aspect of functionality described with respect to any one device that is described in conjunction with another device (e.g., sends/sending, etc.) is to be understood to concurrently describe the functionality of the other respective device (e.g., receives/receiving, etc.).

A central processing unit (CPU) 202 provides computer instruction execution, computation, and other capabilities within the core processing module 200. A display 204 provides visual information to a user of the core processing module 200 and an input device 206 provides input capabilities for the user.

The display 204 may include any display device, such as a cathode ray tube (CRT), liquid crystal display (LCD), light emitting diode (LED), electronic ink displays, projection, touchscreen, or other display element or panel. The input device 206 may include a computer keyboard, a keypad, a mouse, a pen, a joystick, touchscreen, or any other type of input device by which the user may interact with and respond to information on the display 204.

It should be noted that the display 204 and the input device 206 may be optional components for the core processing module 200 for certain implementations/devices. Accordingly, the core processing module 200 may operate as a completely automated embedded device without direct user configurability or feedback. However, the core processing module 200 may also provide user feedback and configurability via the display 204 and the input device 206, respectively, as appropriate for a given implementation.

A communication module 208 provides interconnection capabilities that allow the core processing module 200 to communicate with other modules within the system 100. The communication module 208 may include any electrical, protocol, and protocol conversion capabilities useable to provide interconnection capabilities, appropriate for a given implementation.

A memory 210 includes a discovered business process storage area 212 that stores document path information (e.g., document tracking and tracing information) within the core processing module 200. The document path information may include departments visited by a document. Further, the document path information may include captured business processing metrics associated with activities performed within different departments of a business organization, such as an amount of time the document is located and/or processed within the department, time averages of processing time per department, and statistics of these or similar measurements across several document business process flow cycles, and other information. As will be described in more detail below, information stored within the discovered business process storage area 212 is used to provide the business process discovery using document tracking technologies described herein.

It is understood that the memory 210 may include any combination of volatile and non-volatile memory suitable for the intended purpose, distributed or localized as appropriate, and may include other memory segments not illustrated within the present example for ease of illustration purposes. For example, the memory 210 may include a code storage area, an operating system storage area, a code execution area, and a data area without departure from the scope of the present subject matter.

A business process discovery module 214 is also illustrated. The business process discovery module 214 provides document tracking/tracing, business process determination/discovery, and discovered business process modeling based upon actual business process flows traversed by documents for the core processing module 200, as described above and in more detail below. The business process discovery module 214 implements the automated business process discovery using document tracking technologies of the core processing module 200.

The business process discovery module 214 includes a document tracking module 216. The document tracking module 216 provides document tracking capabilities, such as global positioning system (GPS) interface capabilities and/or radio frequency identification (RFID) interface capabilities usable to determine document locations/coordinates and departments within an organization that form a portion of a business process flow that is subject to discovery as described herein. The document tracking module 216 may communicate with the department_{—}1 tracking sensor 106 through the department_N tracking sensor 110 and/or the GPS 112 to derive/determine locations and paths of documents that traverse departments as part of a business process. The business process discovery module 214 may utilize the information obtained by the document tracking module 216 to generate document tracking information. The generated document tracking information may be stored within the discovered business process storage area 212 along with other document tracking information generated by the business process discovery module 214.

The business process discovery module 214 also includes a discovered process modeling module 218. The discovered process modeling module 218 utilizes the document tracking information to generate business process flow models that represent the actual implemented business process within an organization. The generated business process flow models may also be stored in the discovered business process storage area 212.

As described above, actual implemented business processes may differ from intended business processes because the information utilized to derive the intended business processes lacks actual information about how process flows actually operate within an organization. As such, the discovered process modeling module 218 models the actual business processes and the generated business process flow models may be utilized to better understand and manage actual business processes, and to update intended business processes and business process documentation.

It should also be noted that the business process discovery module 214 may form a portion of other circuitry described without departure from the scope of the present subject matter. Further, the business process discovery module 214 may alternatively be implemented as an application stored within the memory 210. In such an implementation, the business process discovery module 214 may include instructions executed by the CPU 202 for performing the functionality described herein. The CPU 202 may execute these instructions to provide the processing capabilities described above and in more detail below for the core processing module 200. The business process discovery module 214 may form a portion of an interrupt service routine (ISR), a portion of an operating system, a portion of a browser application, or a portion of a separate application without departure from the scope of the present subject matter.

A timer/clock module 220 is illustrated and may be used to determine timing and date information, such as an amount of time a document is in a particular department of an organization, as described above and in more detail below. As such, the business process discovery module 214 may utilize information derived from the timer/clock module 220 for information processing activities, such as the business process discovery using document tracking technologies.

The CPU 202, the display 204, the input device 206, the communication module 208, the memory 210, the business process discovery module 214, and the timer/clock module 220 are interconnected via an interconnection 222. The interconnection 222 may include a system bus, a network, or any other interconnection capable of providing the respective components with suitable interconnection for the respective purpose.

Though the different modules illustrated within FIG. 2 are illustrated as component-level modules for ease of illustration and description purposes, it should be noted that these modules may include any hardware, programmed processor(s), and memory used to carry out the functions of the respective modules as described above and in more detail below. For example, the modules may include additional controller circuitry in the form of application specific integrated circuits (ASICs), processors, antennas, and/or discrete integrated circuits and components for performing communication and electrical control activities associated with the respective modules. Additionally, the modules may include interrupt-level, stack-level, and application-level modules as appropriate. Furthermore, the modules may include any memory components used for storage, execution, and data processing for performing processing activities associated with the respective modules. The modules may also form a portion of other circuitry described or may be combined without departure from the scope of the present subject matter.

Additionally, while the core processing module 200 is illustrated with and has certain components described, other modules and components may be associated with the core processing module 200 without departure from the scope of the present subject matter. Additionally, it should be noted that, while the core processing module 200 is described as a single device for ease of illustration purposes, the components within the core processing module 200 may be co-located or distributed and interconnected via a network without departure from the scope of the present subject matter. For a distributed arrangement, the display 204 and the input device 206 may be located at a point of sale device, kiosk, or other location, while the CPU 202 and memory 210 may be located at a local or remote server. Many other possible arrangements for components of the core processing module 200 are possible and all are considered within the scope of the present subject matter. Accordingly, the core processing module 200 may take many forms and may be associated with many platforms.

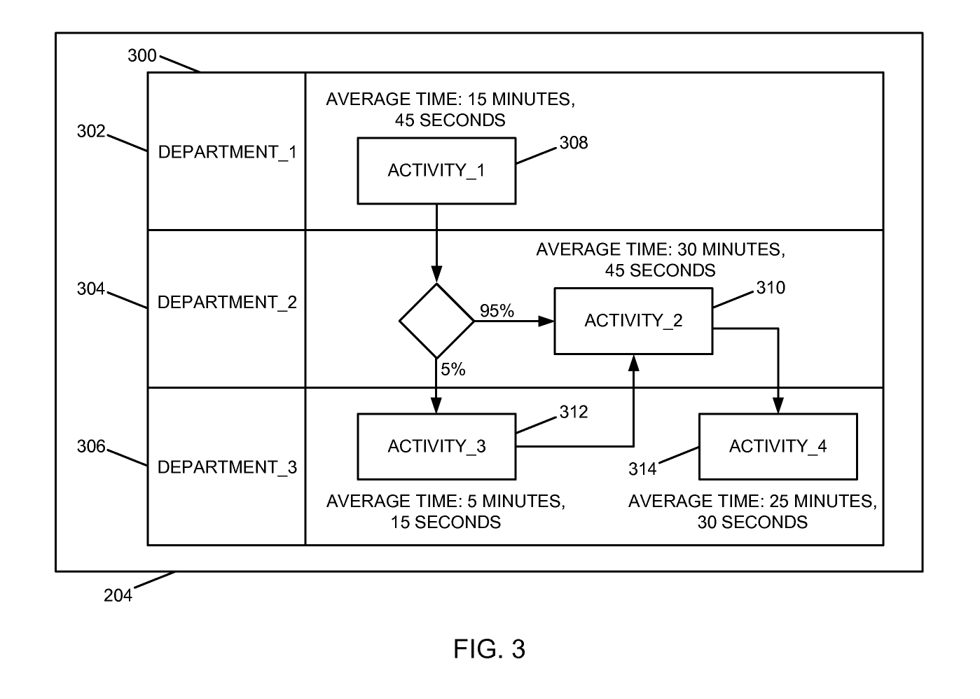

FIG. 3 is a diagram of a business process flow model 300 that may be generated using business process discovery using document tracking technologies. The business process flow model 300 is shown within FIG. 3 to be displayed on the display 204 and may be stored within the discovered business process storage area 212 of the memory 210 for display and processing. For purposes of the present example, the business process flow model 300 represents an aggregated business process flow model constructed over several iterations of document flows through three departments, a department_{—}1 302, a department_{—}2 304, and a department_{—}3 306.

As can be seen within FIG. 3, the business process flow model 300 illustrates that an activity_{—}1 308 within the department_{—}1 302 is the first activity that has been determined to have occurred within the underlying business process that has been discovered and used to generate the business process flow model 300. As can also be seen within FIG. 3, ninety five percent (95%) of the time documents flow from the activity_{—}1 308 within the department_{—}1 302 to an activity_{—}2 310 within the department_{—}2 304, while five percent (5%) of the time documents flow from the activity_{—}1 308 within the department_{—}1 302 to an activity_{—}3 312 within the department_{—}3 306. Documents that are processed by the activity_{—}3 312, within the department_{—}3 306, also subsequently flow to the activity_{—}2 310 within the department_{—}2 304. All documents flow from the activity_{—}2 310 within the department_{—}2 304 to an activity_{—}4 314 within the department_{—}3 306.

As can also be seen from FIG. 3, an average time involved to complete the activity_{—}1 308 within the department_{—}1 302 is fifteen minutes and forty five seconds (15 minutes, 45 seconds). Similarly, an average time involved to complete the activity_{—}2 310 within the department_{—}2 304 is thirty minutes and forty five seconds (30 minutes, 45 seconds). Likewise, an average time to complete the activity_{—}3 312 within the department_{—}3 306 is five minutes and fifteen seconds (5 minutes, 15 seconds), while an average time to complete the activity_{—}4 314 within the department_{—}3 306 is twenty five minutes and thirty seconds (25 minutes, 30 seconds). These times may be determined using the timer/clock module 220.

As such, the generated business process flow models, such as the business process flow model 300, may be generated based upon data collected over one or more business process flow cycles and may be based upon measurements of time to accumulate statistics related to actual business process flow cycles within an organization. For a given organization, empirical data of actual document flows may be captured within that organization. The generated business process flow models generated from the captured empirical document flow data may be utilized to document actual (as opposed to intended) business processes within the organization, and may be utilized to enhance understanding of actual business processes as implemented within the respective organization.

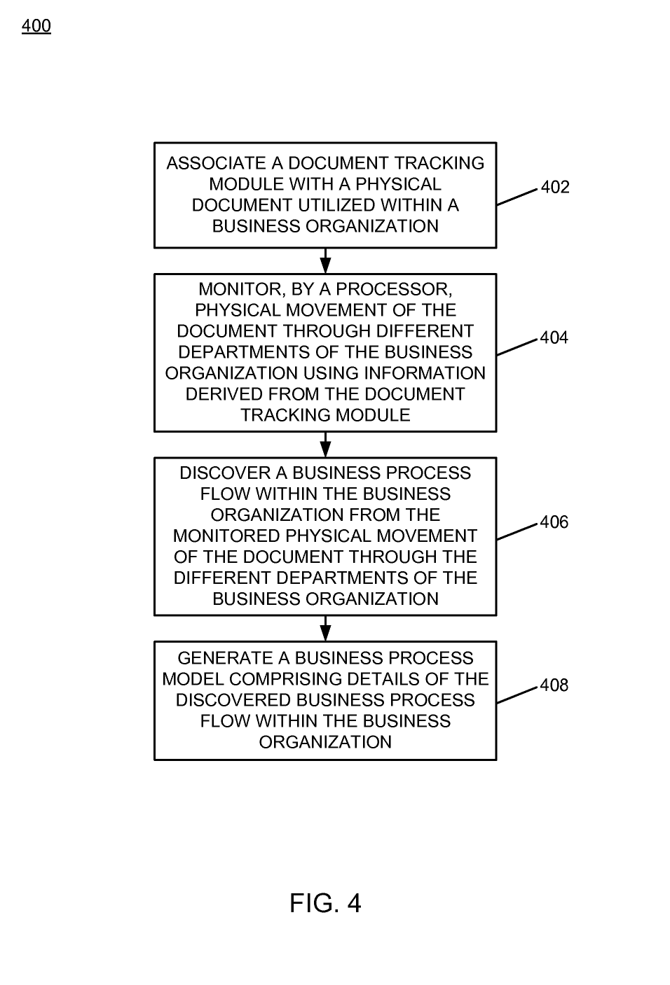

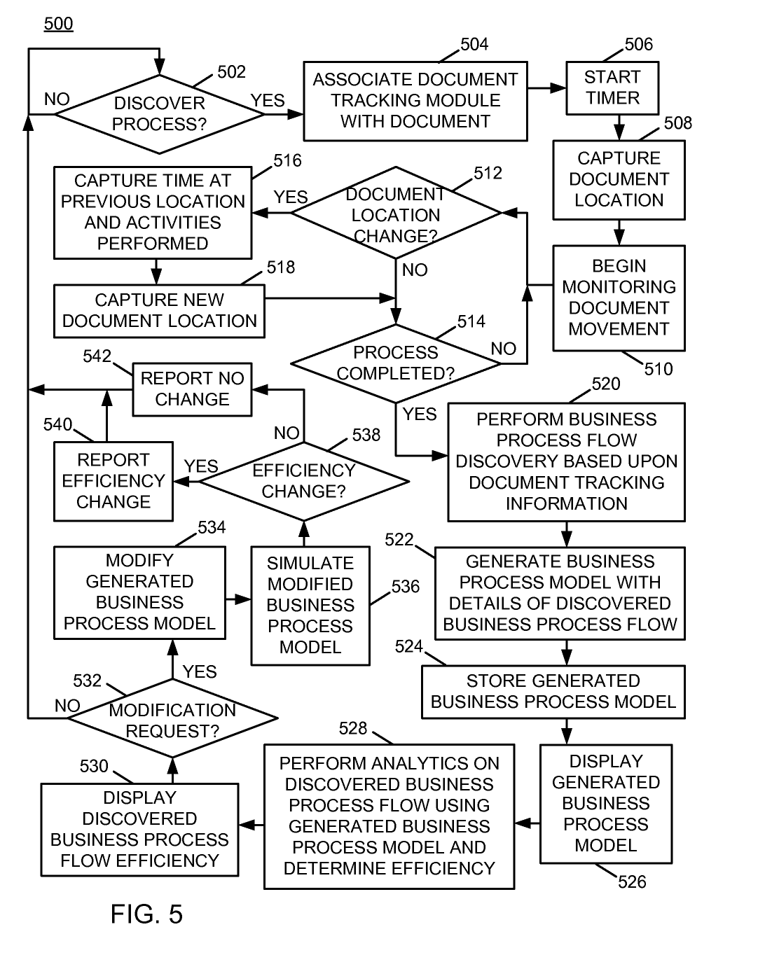

FIG. 4 through FIG. 5 described below represent example processes that may be executed by devices, such as the core processing module 200, to perform the automated business process discovery using document tracking technologies associated with the present subject matter. Many other variations on the example processes are possible and all are considered within the scope of the present subject matter. The example processes may be performed by modules, such as the business process discovery module 214 and/or executed by the CPU 202, associated with such devices. It should be noted that time out procedures and other error control procedures are not illustrated within the example processes described below for ease of illustration purposes. However, it is understood that all such procedures are considered to be within the scope of the present subject matter. Further, the described processes may be combined, sequences of the processing described may be changed, and additional processing may be added or removed without departure from the scope of the present subject matter.

FIG. 4 is a flow chart of an example of an implementation of a process 400 for business process discovery using document tracking technologies. At block 402, the process 400 associates a document tracking module with a physical document utilized within a business organization. At block 404, the process 400 monitors, by a processor, physical movement of the document through different departments of the business organization using information derived from the document tracking module. At block 406, the process 400 discovers a business process flow within the business organization from the monitored physical movement of the document through the different departments of the business organization. At block 408, the process 400 generates a business process model comprising details of the discovered business process flow within the business organization.

FIG. 5 is a flow chart of an example of an implementation of a process 500 for business process discovery using document tracking technologies that includes modification and simulation of discovered business process models. At decision point 502, the process 500 makes a determination as to whether a request to perform business process flow discovery within an organization has been detected. A request to perform business process flow discovery within an organization may be detected, for example, in response to a system user initiating a request via the tracking device 102 described above in association with FIG. 1 (or a user of another computing device not shown that may request this service from the tracking device 102). It should be noted that the process 500 is represented for tracking a single document for ease of illustration purposes. However, as described in more detail below, multiple iterations of business process flow discovery may be performed across multiple documents, and business processing flow metrics and business processing flow statistics may be calculated to determine and improve efficiency within a business organization.

In response to determining that a request to perform business process flow discovery within an organization has been detected at decision point 502, the process 500 associates a document tracking module with a physical document at block 504. Association of a document tracking module with a document may include, for example, associating an RFID device identifier or a GPS device identifier with a particular physical document that is to be tracked and used to discover the business process flow within the organization.

At block 506, the process 500 starts a timer, such as a timer associated with the timer/clock module 220 to start measuring time for document tracking and business process flow discovery. At block 508, the process 500 captures the document's current location within the organization using the document tracking module associated with the document. At block 510, the process 500 begins monitoring document movement within the organization to discover the business process flow within the organization.

At decision point 512, the process 500 makes a determination as to whether there has been a document location change within the organization. In response to determining that there has not yet been a document location change, the process 500 makes a determination at decision point 514 as to whether document tracking processing has been completed. The process 500 iterates between decision points 512 and 514, and performs processing as described in more detail below.

Returning to the description of decision point 512, in response to determining that there has been a document location change within the organization, the process 500 calculates a time measurement that reflects a time that the document was at the previous (initial for the first iteration) location and which activities have been performed at block 516. The process 500 may calculate an amount of time the document is located within each of the different departments within the organization. Over time, the process 500 may calculate document processing time averages per department and statistics regarding processing times across the different departments as different documents are processed within the organization. In this regard, the process 500 captures and/or calculates business processing metrics associated with activities performed within the different departments of the business organization. At block 518, the process 500 captures the new location of the document. It should be noted that the captured/calculated time at the previous location may also be used to represent the start time at the new location. Alternatively, a new or other timer may be used as appropriate for a given implementation. The process 500 iterates as described above to track the location changes and times within different departments. The process 500 accumulates the document tracking information (e.g., document location/department information, activities performed, document time within the respective departments, metrics/statistics, etc.) until a determination is made at decision point 514 that document tracking processing has been completed.

Returning to the description of decision point 514, in response to determining that document tracking processing has been completed, the process 500 performs business process flow discovery processing based upon the document tracking information at block 520. At block 522, the process 500 generates a business process model with details of the discovered business process flow through the different departments (e.g., document time within the respective departments, and accumulated metrics/statistics). The generated business process model may include a data structure, modeling document (e.g., an extensible markup language (XML) document), or other formatted model that may be analyzed, evaluated, manipulated, displayed, or otherwise processed to evaluate and/or improve the discovered business process flow within the organization. At block 524, the process 500 stores the generated business process model as a structured model, such as within the discovered business process storage area 212 of the memory 210.

At block 526, the process 500 displays the generated business process model on a display, such as the display 204. At block 528, the process 500 performs analytics on the captured/calculated business processing metrics within the generated business process model and determines a calculated business process flow efficiency of the discovered business process flow. At block 530, the process 500 displays the calculated discovered business process flow efficiency.

At decision point 532, the process 500 makes a determination as to whether a request has been detected/received to modify the discovered business process flow represented within the generated business process model (e.g., a business process model modification request). In response to determining that a request has been detected to modify the business process flow represented within the generated business process model, the process 500 modifies the generated business process model to reflect the modifications to the underlying discovered business process flow according to the business process model modification request at block 534.

At block 536, the process 500 simulates the modified business process model to evaluate the modified business process flow represented by the modified business process model. At decision point 538, the process 500 makes a determination as to whether an efficiency change for the discovered business process flow results from the requested business process model modification. In response to determining that an efficiency change for the discovered business process flow does result from the requested business process model modification, the process 500 reports the efficiency change to the user at block 540. In response to determining that an efficiency change for the discovered business process flow does not result from the requested business process model modification, the process 500 reports that no change to the efficiency of the discovered business process flow results from the requested business process model modification to the user at block 542. It is understood that reporting the efficiency change at block 540 or that no efficiency change results from the change at block 542 may be performed by displaying the respective reporting notification on the display 204 with the business process model, logging the respective report, or otherwise providing the user with feedback regarding the requested modification.

Further, where an efficiency improvement results from the requested business process model modification, the updated/modified business process model may be archived/stored as an additional/new revision of the discovered business process flow. This additional/new revision of the discovered business process flow may be implemented within the organization, and additional business process discovery processing may be performed to discover the “as-implemented” results of implementation of the modified business process flow. As described above, actual implementation of business processes may deviate from intended business processes. As such, the present technology may be used iteratively to evaluate implementation and roll out of refined business processes over time.

It is further understood that the process 500 may iterate to receive and process additional business process model modification requests, and that this processing is omitted to avoid crowding within the drawing of FIG. 5. In response to reporting an efficiency change at block 542, or in response to reporting that no efficiency change has occurred at block 542, or in response to determining at decision point 532 that no modification(s) has been requested, the process 500 returns to decision point 502 and iterates as described above.

As such, the process 500 associates document tracking technology with physical documents and tracks physical document movement through different departments of an organization to discover the actual underlying business process flow within the organization. The process 500 captures/calculates metrics and generates a structured business process model from the discovered business process flow. The process 500 performs analytics on the generated business process model that are based upon the discovered business process flow, and reports efficiency and other analytics to the user. Business process model modification requests may be processed and simulated to determine whether efficiency changes result from the requested modifications to the discovered business process model. Updated business process flows may be deployed, and the present technology may be utilized to evaluate implementation of the deployed new business process flows. The process 500 may be iteratively utilized to refine and improve business process flows within an organization through discovery of implemented business process flows (that may differ from intended business process flows).

As described above in association with FIG. 1 through FIG. 5, the example systems and processes provide business process discovery using document tracking technologies. Many other variations and additional activities associated with business process discovery using document tracking technologies are possible and all are considered within the scope of the present subject matter.

Those skilled in the art will recognize, upon consideration of the above teachings, that certain of the above examples are based upon use of a programmed processor, such as the CPU 202. However, the invention is not limited to such example embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as JAVA™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention have been described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable storage medium that can direct a computer or other programmable data processing apparatus to function in a particular manner, such that the instructions stored in the computer-readable storage medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A system, comprising:
a memory; and
a processor programmed to:
associate a document tracking module with a physical document utilized within a business organization;
monitor physical movement of the document through the different departments of the business organization using information derived from the document tracking module;
discover a business process flow within the business organization from the monitored physical movement of the document through different departments of the business organization; and
generate within the memory a business process model comprising details of the discovered business process flow within the business organization.

2. The system of claim 1, where the processor is further programmed to calculate business processing metrics associated with activities performed within the different departments of the business organization

3. The system of claim 2, where in being programmed to calculate the business processing metrics associated with the activities performed within the different departments of the business organization, the processor is programmed to at least one of:
calculate an amount of time the document is located within each of the different departments;
calculate document processing time averages for each of the different departments; and
calculate statistics regarding processing times across the different departments.

4. The system of claim 1, where the processor is further programmed to:
perform analytics on the discovered business processing flow within the generated business process model; and
determine an efficiency of the discovered business process flow.

5. The system of claim 1, where the processor is further programmed to:
receive a business process model modification request; and
modify the generated business process model according to the business process model modification request.

6. The system of claim 5, where the processor is further programmed to:
simulate the modified business process model; and
determine whether an efficiency change for the discovered business process flow results from the requested business process model modification.

7. The system of claim 1, where, in being programmed to associate the document tracking module with the physical document utilized within the organization, the processor is programmed to one of:
capture a radio frequency identification (RFID) module identifier of an RFID module that is physically associated with the document; and
capture a global positioning system (GPS) module identifier of a GPS module that is physically associated with the document.

8. A computer program product, comprising:
a computer readable storage medium having computer readable program code embodied therewith, where the computer readable program code when executed on a computer causes the computer to:
associate a document tracking module with a physical document utilized within a business organization;
monitor physical movement of the document through different departments of the business organization using information derived from the document tracking module;
discover a business process flow within the business organization from the monitored physical movement of the document through the different departments of the business organization; and
generate a business process model comprising details of the discovered business process flow within the business organization.

9. The computer program product of claim 8, where the computer readable program code when executed on the computer further causes the computer to calculate business processing metrics associated with activities performed within the different departments of the business organization.

10. The computer program product of claim 9, where, in causing the computer to calculate the business processing metrics associated with the activities performed within the different departments of the business organization, the computer readable program code when executed on the computer causes the computer to at least one of:
calculate an amount of time the document is located within each of the different departments;
calculate document processing time averages for each of the different departments; and
calculate statistics regarding processing times across the different departments.

11. The computer program product of claim 8, where the computer readable program code when executed on the computer further causes the computer to:
perform analytics on the discovered business processing flow within the generated business process model; and
determine an efficiency of the discovered business process flow.

12. The computer program product of claim 8, where the computer readable program code when executed on the computer further causes the computer to:
receive a business process model modification request; and
modify the generated business process model according to the business process model modification request.

13. The computer program product of claim 12, where the computer readable program code when executed on the computer further causes the computer to:
simulate the modified business process model; and
determine whether an efficiency change for the discovered business process flow results from the requested business process model modification.

14. The computer program product of claim 8, where, in causing the computer to associate the document tracking module with the physical document utilized within the organization, the computer readable program code when executed on the computer causes the computer to one of:
capture a radio frequency identification (RFID) module identifier of an RFID module that is physically associated with the document; and
capture a global positioning system (GPS) module identifier of a GPS module that is physically associated with the document.
